(19) United States
(12) Patent Application Publication
(10) Pub. No.: US 2014/0343997 A1
(43) Pub. Date: Nov. 20, 2014

(54) INFORMATION TECHNOLOGY OPTIMIZATION VIA REAL-TIME ANALYTICS

(71) Applicant: International Business Machines Corporation, Armonk, NY (US)

(72) Inventors: Gene L. Brown, Durham, CT (US); Brendan F. Coffey, Rhinebeck, NY (US); Christopher J. Dawson, Arlington, VA (US); Clifford V. Harris, Cedar Park, TX (US)

(73) Assignee: International Business Machines Corporation, Armonk, NY (US)

(21) Appl. No.: 13/893,471

(22) Filed: May 14, 2013

(51) Int. Cl. G06Q 10/06

(52) U.S. Cl. CPC G06Q 10/06312
USPC 705/7.22

(57) ABSTRACT

Automated processes generate optimization options in response to collecting inventory data relevant to components installed within an implemented information technology system. An interactive graphical user interface dashboard displays different selectable primary analysis criteria elements and analytics modules. A collected data type (geographic location, hardware or software identity indicia, operating or energy costs) is specified as a root organizing data type, and another as a branch organizing data type depending from the root organizing data type, based on a primary analysis criteria element and analytic module selection. The components having common collected root organizing data type values are grouped into root subsets, and the root subsets are further split into branch subsets of components having common collected data values of the specified branch organizing type or another collected data type, and the subsets are displayed with respective aggregate numbers of the components within the subsets.

### FIELD OF THE INVENTION

The present invention relates to the design and management of information technology systems in response to business analytics inputs.

### BACKGROUND

Information technology (IT) generally refers to the application of computers and telecommunications equipment to store, retrieve, transmit and manipulate data, often in the context of a business, organization or other enterprise that spans a large number of people and associated computing devices. Though the term may be used as a synonym for computers and computer networks, it also encompasses other information distribution technologies such as television, telephone and telephony, audio distribution, etc. Several industries are associated with information technology, including computer hardware, software, electronics, semiconductors, internet, telecom equipment, e-commerce and computer services.

IT management responsibilities include network administration, software development and installation. Large IT structures may implement planning and management via technology life cycle strategies and plans that provide decision processes for hardware and software maintenance, including upgrades and replacements. Efficiently administering large IT structures via technology life cycle strategies and plans generally requires the allocation of human resources in amounts commensurate with the size of the implementation.

### BRIEF SUMMARY

In one aspect of the present invention, a method for optimizing information technology systems in response to environmental data inputs includes collecting inventory data relevant to components that are installed within an implemented information technology system. The collected inventory data includes geographic location data, hardware identity indicia data, software identity indicia data, operating costs over time data and energy costs over time data for each of the information technology system components. An interactive graphical user interface dashboard displays different selectable elements that are each associated with different primary analysis criteria. In response to a selection of one of the displayed primary analysis criteria elements, the interactive dashboard display is redrawn to present a plurality of different selectable analytics modules that are each associated with the selected primary analysis criteria. In response to a selection of one of the displayed selectable analytics modules, one of the collected data types (geographic location, hardware or software identity indicia, operating or energy costs over time) is specified as a root organizing data type, and another as a branch organizing data type depending from the root organizing data type. The IT system components are grouped into different root subsets in response to the components having common collected data values of the specified root organizing data type. The root subsets are further split into branch subsets in response to the components within the branch subsets having common collected data values of the specified branch organizing data type, or of another one of the collected data types that is different from the specified root data type and the specified branch data type. The interactive dashboard display is redrawn to present the common data values of each of the root subsets and branch subsets in association with total aggregate numbers of the components that are within the root subsets and the branch subsets.

In another aspect, a system has a processing unit, computer readable memory and a tangible computer-readable storage medium with program instructions, wherein the processing unit, when executing the stored program instructions collects inventory data relevant to components that are installed within an implemented information technology system. The collected inventory data includes geographic location data, hardware identity indicia data, software identity indicia data, operating costs over time data and energy costs over time data for each of the information technology system components. The processing unit further displays different selectable elements on an interactive graphical user interface dashboard that are each associated with different primary analysis criteria. In response to a selection of one of the displayed primary analysis criteria elements, the interactive dashboard display is redrawn to present a plurality of different selectable analytics modules that are each associated with the selected primary analysis criteria. In response to a selection of one of the displayed selectable analytics modules, one of the collected data types (geographic location, hardware or software identity indicia, operating or energy costs over time) is specified as a root organizing data type, and another as a branch organizing data type depending from the root organizing data type. The IT system components are grouped into different root subsets in response to the components having common collected data values of the specified root organizing data type. The root subsets are further split into branch subsets in response to the components within the branch subsets having common collected data values of the specified branch organizing data type, or of another one of the collected data types that is different from the specified root data type and the specified branch data type. The interactive dashboard display is redrawn to present the common data values of each of the root subsets and branch subsets in association with total aggregate numbers of the components that are within the root subsets and the branch subsets.

In another aspect, a computer program product for optimizing information technology systems in response to environmental data inputs has a tangible computer-readable storage medium with computer readable program code embodied therewith. The computer readable program code includes instructions that, when executed by a computer processing unit, cause the computer processing unit to collect inventory data relevant to components that are installed within an implemented information technology system. The collected inventory data includes geographic location data, hardware identity indicia data, software identity indicia data, operating costs over time data and energy costs over time data for each of the information technology system components. The processing unit further displays different selectable elements on an interactive graphical user interface dashboard that are each associated with different primary analysis criteria. In response to a selection of one of the displayed primary analysis criteria elements, the interactive dashboard display is redrawn to present a plurality of different selectable analytics modules that are each associated with the selected primary analysis criteria. In response to a selection of one of the displayed selectable analytics modules, one of the collected data types (geographic location, hardware or software identity indicia, operating or energy costs over time) is specified as a root organizing data type, and another as a branch organizing data type depending from the root organizing data type. The IT system components are grouped into different root subsets in response to the components having common collected data values of the specified root organizing data type. The root subsets are further split into branch subsets in response to the components within the branch subsets having common collected data values of the specified branch organizing data type, or of another one of the collected data types that is different from the specified root data type and the specified branch data type. The interactive dashboard display is redrawn to present the common data values of each of the root subsets and branch subsets in association with total aggregate numbers of the components that are within the root subsets and the branch subsets.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method, system or process according to the present invention for the optimizing information technology systems in response to environmental data inputs.

FIG. 2 is a block diagram illustration of an aspect of an interactive dashboard according to the present invention.

FIG. 3 is a block diagram illustration of another aspect of an interactive dashboard according to the present invention.

FIG. 4 is a block diagram illustration of another aspect of an interactive dashboard according to the present invention.

FIG. 5 is a block diagram illustration of another aspect of an interactive dashboard according to the present invention.

FIG. 6 is a block diagram illustration of another aspect of an interactive dashboard according to the present invention.

FIG. 7 is a block diagram illustration of another aspect of an interactive dashboard according to the present invention.

FIG. 8 is a block diagram illustration of a computer system implementation of an aspect of the present invention.

The drawings are not necessarily to scale. The drawings are merely schematic representations, not intended to portray specific parameters of the invention. The drawings are intended to depict only typical aspects, examples and embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

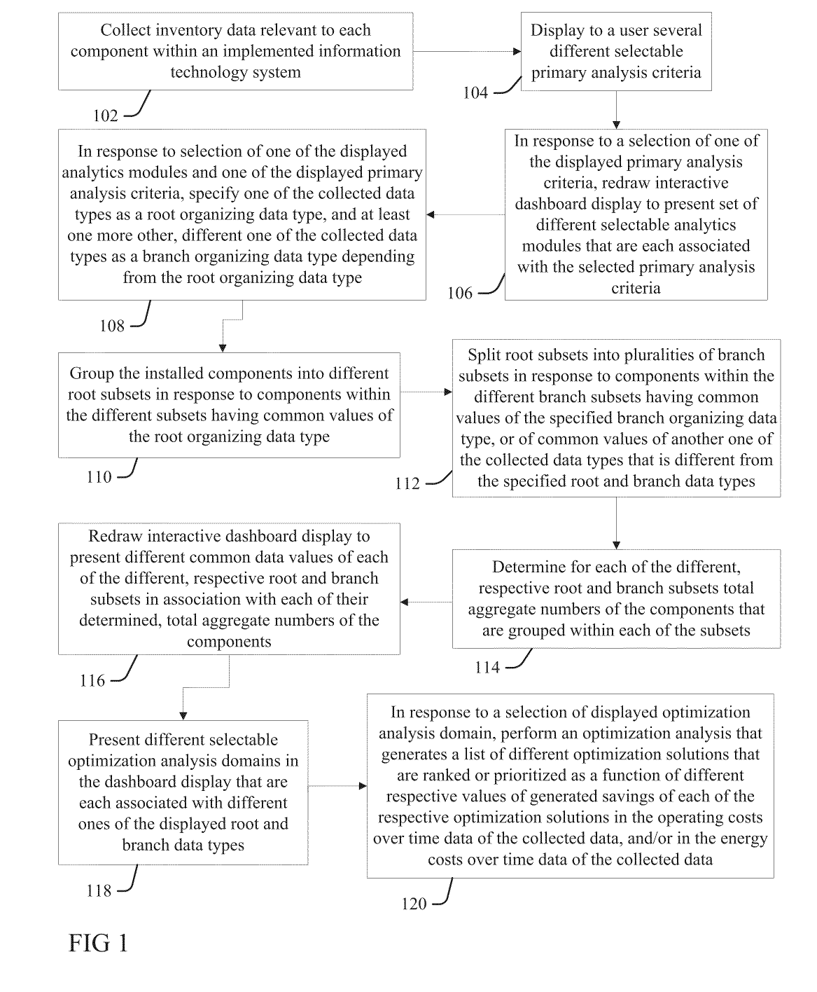

FIG. 1 illustrates a method, system or process according to the present invention for optimizing information technology systems in response to environmental data inputs. At 102 an automated collector (a processing unit of a computing device executing instructions) collects inventory data relevant to a current resources landscape of an implemented IT system that is composed of a plurality of networked computing devices (components). The collected inventory data includes values of identity indicia (vendors, names, models or versions, etc.) of the component hardware (servers, storage devices, etc.) and software (operating systems, databases, supported network and protocols, etc.) and operating costs over time for each of the components. In other aspects, the inventory data also includes processing capabilities and capacity, energy usage over time, and still other performance characteristics will be apparent to one skilled in the art.

At 104 an interactive graphical user interface (GUI) dashboard display is generated and presented to a user (via a computer monitor, smart phone display screen, etc.) that includes several different selectable elements (buttons, icons, tabs, etc.) that are each associated with (represent) different primary analysis criteria. In one aspect, the primary analysis criteria include “Cost Management,” “Service Delivery Levels” and “Innovation”, though other primary selection criteria may be practiced in additional aspects.

At 106, in response to a selection by the user (via a cursor or other GUI routine) of one of the displayed selectable primary analysis criteria elements, the interactive dashboard display is redrawn to present the user with a set of different selectable analytics modules that are each associated with the selected primary analysis criteria. In one aspect, the displayed analytics modules include one or more of hardware (server) optimization, storage optimization, network optimization, software optimization, energy optimization, labor optimization, and data center facilities optimization modules, though other analytics modules may be practiced in additional aspects.

At 108, in response to a selection by the user (via a cursor or other GUI routine) of one of the displayed analytics modules, an automated analyzer (a processing unit of a computing device executing instructions) specifying for the combination of the selected primary analysis criteria and the selected analytic module (i) a one of the collected data types (the geographic location data, hardware identity indicia data, software identity indicia data, operating costs over time data and energy costs over time data) as a root organizing data type; and (ii) at least one more other, different one of the collected data types as a branch organizing data type depending from the root organizing data type.

At 110 the plurality of installed components of the IT system are grouped into different root subsets in response to components within the different subsets having common values of the root organizing data type. More particularly, the components are grouped within each root subset as a function of having values of the root organizing data type that are common to the values of the other components within the subset, and that are different from the values of the root organizing data type of the components within the other subsets.

At 112, the root subsets of the installed IT system components are further split into pluralities of branch subsets in response to components within the different branch subsets having respective common values of the branch organizing data type specified as depending from the root organizing data type, or of different common values of another one of the collected data types that is different from the specified root and branch data types. More particularly, the components are grouped within each branch subset as a function of having values of the root organizing data type and of the branch organizing data type that are common to the respective root and branch data values of the other components within the branch subset, and that are different from the values of the branch organizing data type or the another, third type of collected data, of the components within the other branch subsets within their common root subset.

At 114 total aggregate numbers of the installed components that are grouped within each of the different, respective root and branch subsets are determined for each of said different subsets. At 116 the interactive dashboard display is redrawn to present to the user the different common data values of each of the different, respective root and branch subsets in association with each of their determined, total aggregate numbers of the installed components of the IT system that are within the respective root and branch subsets.

Thus, common values of the specified root and branch organizing data are used to define groups of the IT system components, serving as the basis to identify, distinguish and aggregate subgroups of the installed components. The root and branch relationship of the different, respective selected types of collected data provide structural detail of the overall IT system via identifying dependent relationships between the components that are useful in identifying subgroup components of the system for further consideration and analysis.

Accordingly, at 118 different selectable optimization analysis domains are presented to the user in the dashboard display that are each associated with different ones of the displayed root and branch data types. At 120, in response to a selection of one of the displayed optimization analysis domains by the user (via a cursor or other GUI routine), the automated analyzer invokes an associated module and thereby performs an optimization analysis that generates a list of different optimization solutions of the selected optimization analysis domain that are ranked or prioritized as a function of different respective values of generated savings of each of the respective optimization solutions in the operating costs over time data of the collected data, and/or in the energy costs over time data of the collected data.

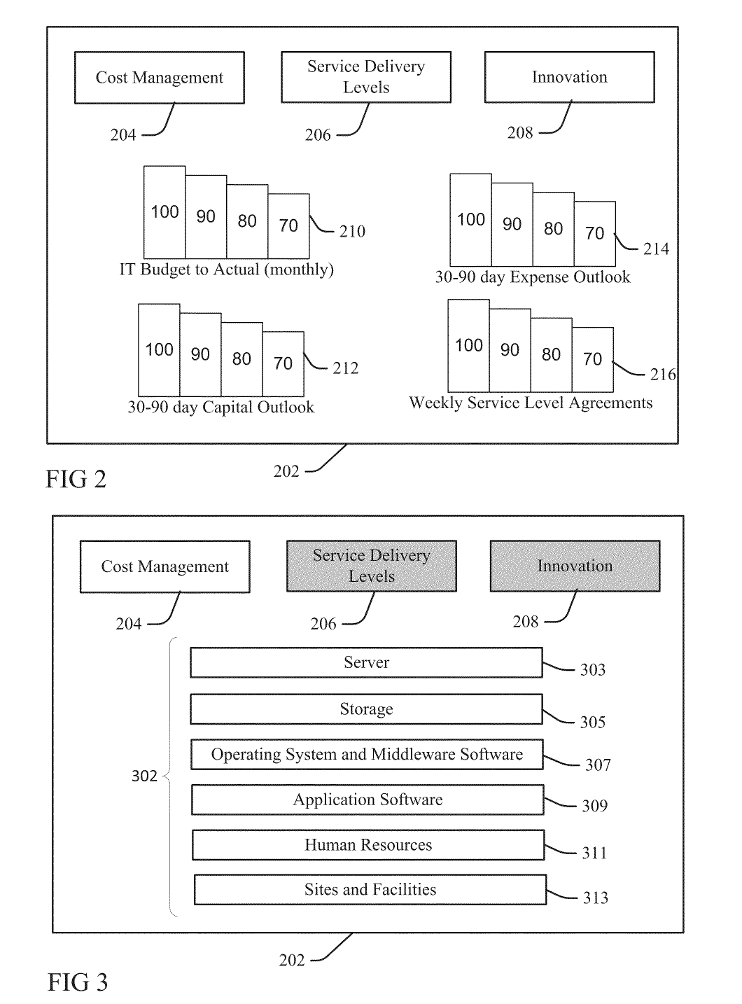

FIG. 2 illustrates an example of a GUI interactive dashboard 202 generated by aspects of the present invention, including via the process and system components of FIG. 1. Thus, primary analysis criteria are provided in different selectable buttons (at 104 of FIG. 1), more particularly a “Cost Management” button 204, a “Service Delivery Levels” button 206 and an “Innovation” button 208. The present example also includes data graphs generated from the IT system environment data (for example, as collected at 102, FIG. 1), more particularly an “IT Budget to Actual (monthly)” graph 210, a “30-90 day Expense Outlook” graph 214, a “30-90 day Capital Outlook” graph 212 and a “Weekly Service Level Agreements” graph 216 (for example, by Business Process, or by Priority)”, and still other appropriate graphs will be apparent to one skilled in the art.

Selection by a user of the Cost Management tab 204 (via a cursor or other GUI routine at 106, FIG. 1) triggers a redrawing of the dashboard 202 into the view of FIG. 3, which shows the Cost Management tab 204 as active, and grays-out the other tabs 206 and 208 to indicate that they are not active. The view in FIG. 3 also presents the user with a set 302 of different selectable analytics modules that are each associated with the selected Cost Management primary analysis criteria and includes Server 303, Storage 305, Operating System and Middleware Software 307, Application Software 309, Human Resources 311 and Sites and Facilities 313.

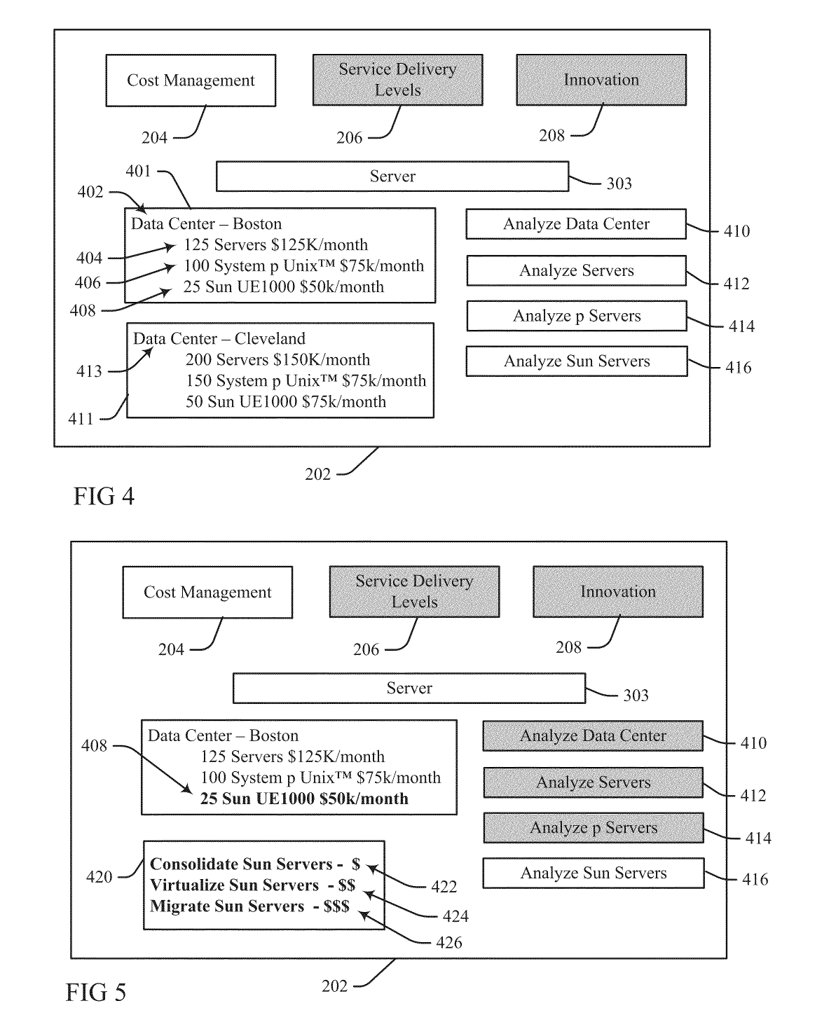

Selection of the Server element 303 (at 108, FIG. 1) triggers a redrawing of the Cost Management tab 204 from the view of FIG. 3 into the view shown in FIG. 4, via the processes described at 110 through 118 of FIG. 1 wherein an automated analyzer applies an associated server analytics module to the collected environmental data of the IT system to form root and branch subset groups that are each relevant to the combination of the selected Cost Management primary selection criteria and selected Server element 303.

In the present example, the specified root data type is the geographic locations of IT server components, for example, Boston, Cleveland or San Jose, etc., and the specified branch data type is a hardware identity defining a server subset, and which is further split into subsets based on software utilized by the servers. Accordingly, two different root data type subsets are defined by geographic data center values, Boston 401 and Cleveland 411, designated by the identifications at 402 and 413 of their different commonalities of geographic data. The Boston data center subset 401 includes a branch subset 404 of 125 Servers that cost $125K/month to operate, and which are further broken down into a branch subset 406 of 100 p Unix® systems that cost $75 k/month, and a branch subset 408 of 25 Sun UE1000 servers that cost $50 k/month. (UNIX is a registered trademark of The Open Group in the United States and other countries, and may be licensed exclusively through X/Open Company Ltd.). Thus, the branch subsets 404, 406 and 408 are distinguished not by different commonalities of the branch data type value (server), but by subdivisions that have different commonalities of another of the collected data type values, here the vendor and model or type of server.

The dashboard 202 as redrawn in FIG. 4 also presents (at 118 of FIG. 1) different selectable optimization analysis domains 410, 412, 414 and 416 that are each associated with respective ones of the data type subsets 402, 404, 406 or 408. Thus, selecting the one of the root (geographic data centers) data type subsets 401 or 411 and the Analyze Data Center analysis domain 410 triggers an automated optimization analysis (at 120 of FIG. 1) for the selected data center. Selecting the branch server subset 404 and the Analyze Servers analysis domain 412 triggers an automated optimization analysis across all servers within the data center of the branch server subset 404. Selecting the p server-specific branch subset 406 and the Analyze p Servers analysis domain 414 triggers an automated optimization analysis across only the p servers within the said Boston data center subset 401, and selecting the Sun server-specific branch subset 408 and the Analyze Sun Servers analysis domain 416 triggers an automated optimization analysis across only the Sun servers within said Boston data center subset 401.

Accordingly, FIG. 5 illustrates a redrawn dashboard 202 in response to a selection by the user (via a cursor or other GUI routine at 118 of FIG. 1) of the Sun server-specific branch subset 408 (indicated by a boldface font rendering) and the Analyze Sun Servers analysis domain 416 (indicated by graying out the other analysis domains 410, 412 and 414). An automated analyzer invokes an associated module and performs an optimization analysis that generates a list 420 of different optimization solutions 422, 424 and 426 that are ranked or prioritized as a function of different values of generated financial benefits of each of the respective listed optimization solutions, in this example in order of lowest to highest potential costs savings. Thus, “Consolidate Sun Servers” 422 is listed with one dollar sign ($), “Virtualize Sun Servers” 424 with two dollar signs ($$) indicating greater potential savings, and “Migrate Sun Servers” 426 is listed with three dollar signs ($$$), thereby indicating that this option provides the greatest potential savings. The listed optimization solutions 420 are generated via analytics that perform high-level analysis of a given server which will incorporate the various cost attributes of that server, including depreciation, price, end of life date, energy footprint, maintenance costs, and software costs, and may also provide initial recommendations for achieving the indicated potential savings.

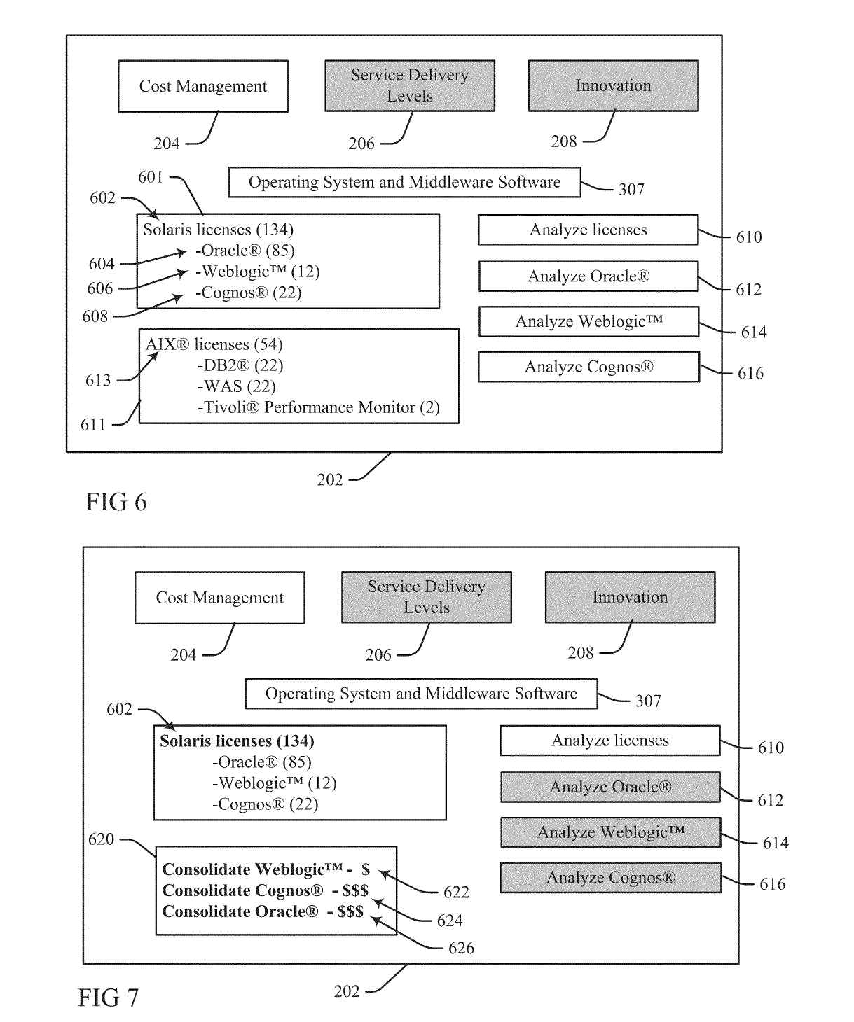

FIGS. 6 and 7 illustrate an optimization selection approach that is alternative to and in contrast to that depicted within FIGS. 4 and 5. More particularly, the Operating System and Middleware Software element 307 of the dashboard 202 as drawn in FIG. 3 is instead selected, triggering a redrawing of the Cost Management tab 204 into the view shown in FIG. 6 via the processes described at 110 through 118 of FIG. 1. The environmental data of the IT system is organized and grouped into different subsets 601 and 611 according to common values of software applications as the root organizing characteristics 602 and 613. Thus, two different subsets are generated, one of Solaris application licenses 601 and another of AIX® application licenses 611 as their different respective root organizing data values indicated at 602 and 613. The subset 601 comprises all IT components having Solaris application licenses as a common root data type value 602, and this root data value identifier 602 further notifies the user that the aggregate total of this subset is one hundred and thirty four. The Solaris licenses subset 601 is further broken down into three different branch subset groups with respective aggregate totals: an Oracle® branch subset group 604 that signifies 85 licenses from the Oracle Corporation; a Weblogic™ branch subset group 606 that signifies twelve licenses of Weblogic™ from the Oracle Corporation; and a Cognos® branch subset group 608 that signifies twenty-two licenses of Cognos® from International Business Machines Corporation. The AIX® licenses subset 602 comprehends fifty-four components, which is further broken down into three branch subset groups identifying the different vendors of the AIX® licenses and the numbers of components using each: a DB2® branch subset group of twenty-two, a WAS branch subset group of twenty-two, and a Tivoli® Performance Monitor branch subset group of two. (COGNOS, TIVOLI, AIX and DB2 are registered trademarks of International Business Machines Corporation in the United States and other countries; ORACLE and WEBLOGIC are trademarks or registered trademarks of Oracle and/or its affiliates in the United States and other countries.)

The dashboard 202 as redrawn in FIG. 6 also presents (at 118 of FIG. 1) different selectable optimization analysis domains 610, 612, 614 and 616 that are each associated with respective one of the subset groups 602, 604, 606 or 608. Thus, selecting the Solaris application root subset group 602 and the Analyze licenses domain 610 triggers an automated optimization analysis (at 118 of FIG. 1) over all components within the subset group 601, while selecting the Analyze Oracle® domain 612 triggers an automated optimization analysis across the 85 components of the subset group 601 running on Oracle® licenses, selecting the Analyze Weblogic™ domain 614 triggers an automated optimization analysis across the 12 components of the subset group 601 running on Weblogic™ licenses, and selecting the Analyze Cognos® domain 616 triggers an automated optimization analysis across the 22 components of the subset group 601 running on Cognos® licenses.

FIG. 7 illustrates a redrawn dashboard 202 in response to a selection by the user (via a cursor or other GUI routine at 118 of FIG. 1) of the Solaris licenses subset group 601 (indicated by a boldface font rendering of the root data value 602) and the Analyze licenses domain 610 (indicated by graying out the other analysis domains 610, 612 and 614), which triggers an automated optimization analysis (at 120 of FIG. 1) over all of the Solaris licenses subset group 601 that generates a list 620 of different optimization solutions 622, 624 and 626 that are ranked or prioritized as a function of different values of generated financial benefits of each of the respective listed optimization solutions, in this example in order of lowest to highest potential costs savings. Thus, “Consolidate Weblogic™” option 622 has one dollar sign ($), while “Consolidate Oracle®” option 624 and “Consolidate Cognos®” option 626 each have three dollar signs ($$$) indicating that either provides greatest potential savings.

Selecting one of the optimization options listed in 420 or 620 may provide further details to the user with regard to assumptions made from one or more of the collected geographic locations, hardware identity indicia, software identity indicia, operating costs over time and energy costs over time data in generating the selected optimization option. In one aspect, clicking on the “Consolidate Oracle®” option 626 (via a GUI routine, etc.) causes a new window or page presentation to the user that lists supporting assumptions, for example “85 Oracle® v10 licenses @ $12500 per processor core, 662 processor cores, Steady state cost per year=$8.275M, Option: System p AIX® yields $6.1M, Option: System z Linux® yields $4.2M.” (LINUX is a registered trademark of Linus Torvalds in the United States, other countries, or both.)

Conventional monitoring and management of IT environments generally utilizes reactive, rear-window reporting functions with respect to historic and current operating costs and conditions. While such methods may be useful in identifying trends and projecting future conditions via comparison to historic data, they are not able to proactively identify and suggest specific alternative component hardware or software implementations via quantifying possible savings benefits. In contrast, aspects of the present invention dynamically generate recommendations for optimizing IT environments in response to real-time data inputs via continual and dynamic data collection at 102 of FIG. 1.

More particularly, aspects of the present invention provide instantaneous insight on how best to optimize a given IT environment in response to dynamic data collection (at 102) that reflects ever-changing components across the IT landscape via continual growth of new servers, newly available and implemented competing technologies and legacy products, changing work force requirements, increasing impact of energy costs, etc. Root and branch data attributes may be selected so that source analysis encompasses a workload orientation, rather than a focus on a particular hardware (server) platform. The subset groupings defined and generated (at 110) may effectively model the overall IT infrastructure that is implemented within autonomic processes described in FIG. 1 that perform iterative analysis, for example, in response to each collected data update at 102, in response to periodic iterations to capture changes in the collected data, to generate optimization possibilities. The optimization process may also be customized in response to user preferences, generating recommendations based upon specific user-defined triggers, such as threshold values on return-on-investment, space requirements, power consumption, forecasts, etc. Thus, once an original model of the IT system is created, subsequent analysis and optimization recommendations (via 104 through 120) may be rapidly, dynamically, iteratively and automatically driven.

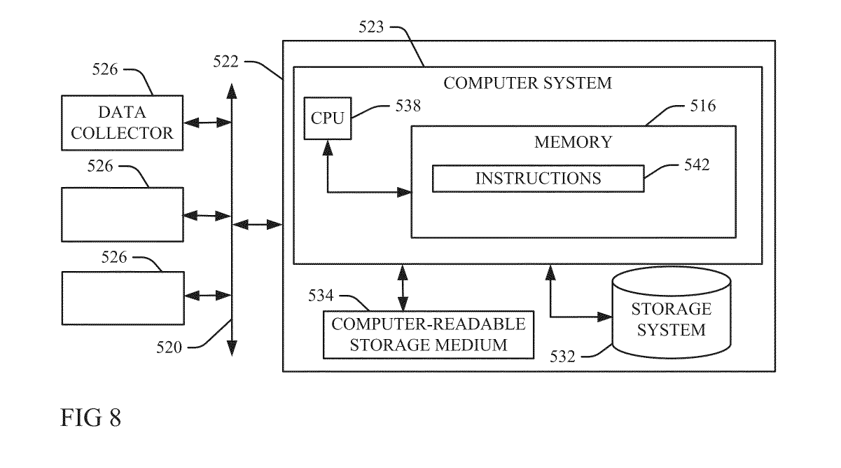

Referring now to FIG. 8, an exemplary computerized implementation of an aspect of the present invention includes a computer system or other programmable device 522 in communication 520 with one or more automated data collectors (a processing unit of a computing device executing instructions) that collect inventory data relevant to a current resources landscape of an implemented IT system that is composed of a plurality of networked computing devices, for example as described above at 102 of FIG. 1. The programmable device 522 thus optimizes information technology systems in response to environmental data inputs by presenting the common data values of each of root and branch subset groups of components of an IT system in association with total aggregate numbers of the components within each subset as described above with respect to FIGS. 1 through 7. Instructions 542 reside within computer readable code in a computer readable memory 516, or in a computer readable storage system 532, or other tangible computer readable storage medium 534 that is accessed by a Central Processing Unit (CPU) 538 of a computer system or infrastructure 523 of the mobile device 522. Thus, the instructions, when implemented by the processing unit 538, cause the processing unit 538 to generate information technology systems optimization options in response to environmental data inputs, as described above with respect to FIGS. 1 through 7.

In one aspect, the present invention may also perform process steps of the invention on a subscription, advertising, and/or fee basis. That is, a service provider could offer to integrate computer-readable program code into the computer system 522 to enable the computer system 522 to generate information technology systems optimization options in response to environmental data inputs, as described above with respect to FIGS. 1 through 8. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for optimizing information technology systems in response to environmental data inputs, the method comprising:
collecting inventory data relevant to each of a plurality of components that are installed within an implemented information technology system, wherein the inventory data comprises for each of the information technology system components geographic location data, hardware identity indicia data, software identity indicia data, operating costs over time data and energy costs over time data;
displaying in an interactive graphical user interface dashboard a plurality of different selectable elements that are each associated with different primary analysis criteria;
in response to a selection of one of the displayed selectable primary analysis criteria elements, redrawing the interactive dashboard display to present a plurality of different selectable analytics modules that are each associated with the selected primary analysis criteria;
in response to a selection of one of the displayed selectable analytics modules, specifying a one of the collected geographic location data, the collected hardware identity indicia data, the collected software identity indicia data, the collected operating costs over time data and the collected energy costs over time data as a root organizing data type, and at least one other of the collected geographic location data, the collected hardware identity indicia data, the collected software identity indicia data, the collected operating costs over time data and the collected energy costs over time data as a branch organizing data type depending from the root organizing data type and that is different from the root organizing data type;
grouping the plurality of components into different root subsets in response to the components within the different subsets having common collected data values of the specified root organizing data type;
splitting each of the root subsets of the components into pluralities of branch subsets in response to the components within the branch subsets having common collected data values of the specified branch organizing data type, or of common values of another one of the collected geographic location data, the collected hardware identity indicia data, the collected software identity indicia data, the collected operating costs over time data and the collected energy costs over time data that is different from the specified root data type and the specified branch data type; and
redrawing the interactive dashboard display to present the common data values of each of the root subsets and branch subsets in association with total aggregate numbers of the components that are within the root subsets and the branch subsets.

2. The method of claim 1, further comprising:
integrating computer-readable program code into a computer system comprising a processing unit, a computer readable memory and a computer readable tangible storage medium, wherein the computer readable program code is embodied on the computer readable tangible storage medium and comprises instructions that, when executed by the processing unit via the computer readable memory, cause the processing unit to perform the steps of collecting the inventory data relevant to each of the plurality of components, displaying in the interactive graphical user interface dashboard the plurality of different selectable elements, redrawing the interactive dashboard display to present the plurality of different selectable analytics modules in response to the selection of one of the displayed selectable primary analysis criteria elements, specifying the root organizing data type and the branch organizing data type in response to the selection of one of the displayed selectable analytics modules, grouping the plurality of components into the different root subsets, splitting each of the root subsets of the components into the pluralities of branch subsets, and redrawing the interactive dashboard display to present the common data values of each of the root subsets and branch subsets in association with the total aggregate numbers of the components that are within the root subsets and the branch subsets.

3. The method of claim 1, further comprising:
displaying a plurality of different selectable optimization analysis domains that are each associated with different ones of the displayed root subsets and the displayed branch subsets; and
in response to a selection of one of the displayed optimization analysis domains, performing an optimization analysis that generates a list of different optimization solutions of a one of the displayed root subsets and the displayed branch subsets that is associated with the selected displayed optimization analysis domain, wherein each of the different optimization solutions display different respective values of generated savings of at least one of the operating costs over time data of the collected data and the energy costs over time data of the collected data.

4. The method of claim 3, wherein the plurality of different selectable analytics modules comprises hardware optimization, storage optimization, network optimization, software optimization, energy optimization, labor optimization, and data center facilities optimization modules.

5. The method of claim 4, wherein the components are servers, and the collected software identity indicia data comprises database software identities operating on each of the servers.

6. The method of claim 5, wherein the list of different optimization solutions comprises a consolidation of the servers optimization solution that generates a first amount of savings of the operating costs over time data, a virtualization of the servers optimization solution that generates a second amount of savings of the operating costs over time data that is different from the first amount of savings, and a migration of the servers optimization solution that generates a third amount of savings of the operating costs over time data that is different from at least one the first amount of savings and the second amount of savings.

7. The method of claim 6, further comprising:
in response to a selection of one of the listed optimization options, displaying details of assumptions made from one or more of the collected geographic locations, hardware identity indicia, software identity indicia, operating costs over time and energy costs over time data in generating the selected optimization option.

8. A system, comprising:
a processing unit in communication with a computer readable memory and a tangible computer-readable storage medium;
wherein the processing unit, when executing program instructions stored on the tangible computer-readable storage medium via the computer readable memory:
collects inventory data relevant to each of a plurality of components that are installed within an implemented information technology system, wherein the inventory data comprises for each of the information technology system components geographic location data, hardware identity indicia data, software identity indicia data, operating costs over time data and energy costs over time data;
displays in an interactive graphical user interface dashboard a plurality of different selectable elements that are each associated with different primary analysis criteria;
in response to a selection of one of the displayed selectable primary analysis criteria elements, redraws the interactive dashboard display to present a plurality of different selectable analytics modules that are each associated with the selected primary analysis criteria;
in response to a selection of one of the displayed selectable analytics modules, specifies a one of the collected geographic location data, the collected hardware identity indicia data, the collected software identity indicia data, the collected operating costs over time data and the collected energy costs over time data as a root organizing data type, and at least one other of the collected geographic location data, the collected hardware identity indicia data, the collected software identity indicia data, the collected operating costs over time data and the collected energy costs over time data as a branch organizing data type depending from the root organizing data type and that is different from the root organizing data type;
groups the plurality of components into different root subsets in response to the components within the different subsets having common collected data values of the specified root organizing data type;
splits each of the root subsets of the components into pluralities of branch subsets in response to the components within the branch subsets having common collected data values of the specified branch organizing data type, or of common values of another one of the collected geographic location data, the collected hardware identity indicia data, the collected software identity indicia data, the collected operating costs over time data and the collected energy costs over time data that is different from the specified root data type and the specified branch data type; and
redraws the interactive dashboard display to present the common data values of each of the root subsets and branch subsets in association with total aggregate numbers of the components that are within the root subsets and the branch subsets.

9. The system of claim 8, wherein the processing unit, when executing the program instructions stored on the computer-readable storage medium via the computer readable memory, further:
displays a plurality of different selectable optimization analysis domains that are each associated with different ones of the displayed root subsets and the displayed branch subsets; and
in response to a selection of one of the displayed optimization analysis domains, generates a list of different optimization solutions of a one of the displayed root subsets and the displayed branch subsets that is associated with the selected displayed optimization analysis domain, wherein each of the different optimization solutions display different respective values of generated savings of at least one of the operating costs over time data of the collected data and the energy costs over time data of the collected data.

10. The system of claim 9, wherein the plurality of different selectable analytics modules comprises hardware optimization, storage optimization, network optimization, software optimization, energy optimization, labor optimization, and data center facilities optimization modules.

11. The system of claim 10, wherein the components are servers, and the collected software identity indicia data comprises database software identities operating on each of the servers.

12. The system of claim 11, wherein the list of different optimization solutions comprises a consolidation of the servers optimization solution that generates a first amount of savings of the operating costs over time data, a virtualization of the servers optimization solution that generates a second amount of savings of the operating costs over time data that is different from the first amount of savings, and a migration of the servers optimization solution that generates a third amount of savings of the operating costs over time data that is different from at least one the first amount of savings and the second amount of savings.

13. The system of claim 12, wherein the processing unit, when executing the program instructions stored on the computer-readable storage medium via the computer readable memory, further, in response to a selection of one of the listed optimization options, displays details of assumptions made from one or more of the collected geographic locations, hardware identity indicia, software identity indicia, operating costs over time and energy costs over time data in generating the selected optimization option.

14. The system of claim 13, wherein the tangible computer-readable storage medium is a portable computer diskette, a hard disk, a random access memory, a read-only memory, an erasable programmable read-only memory, a portable compact disc read-only memory, an optical storage device, or a magnetic storage device.

15. A computer program product for optimizing information technology systems in response to environmental data inputs, the computer program product comprising:
a computer readable tangible storage medium having computer readable program code embodied therewith, the computer readable program code comprising instructions that, when executed by a computer processing unit, cause the computer processing unit to:
collect inventory data relevant to each of a plurality of components that are installed within an implemented information technology system, wherein the inventory data comprises for each of the information technology system components geographic location data, hardware identity indicia data, software identity indicia data, operating costs over time data and energy costs over time data;
display in an interactive graphical user interface dashboard a plurality of different selectable elements that are each associated with different primary analysis criteria;
in response to a selection of one of the displayed selectable primary analysis criteria elements, redraw the interactive dashboard display to present a plurality of different selectable analytics modules that are each associated with the selected primary analysis criteria;
in response to a selection of one of the displayed selectable analytics modules, specify a one of the collected geographic location data, the collected hardware identity indicia data, the collected software identity indicia data, the collected operating costs over time data and the collected energy costs over time data as a root organizing data type, and at least one other of the collected geographic location data, the collected hardware identity indicia data, the collected software identity indicia data, the collected operating costs over time data and the collected energy costs over time data as a branch organizing data type depending from the root organizing data type and that is different from the root organizing data type;
group the plurality of components into different root subsets in response to the components within the different subsets having common collected data values of the specified root organizing data type;
split each of the root subsets of the components into pluralities of branch subsets in response to the components within the branch subsets having common collected data values of the specified branch organizing data type, or of common values of another one of the collected geographic location data, the collected hardware identity indicia data, the collected software identity indicia data, the collected operating costs over time data and the collected energy costs over time data that is different from the specified root data type and the specified branch data type; and
redraw the interactive dashboard display to present the common data values of each of the root subsets and branch subsets in association with total aggregate numbers of the components that are within the root subsets and the branch subsets.

16. The computer program product of claim 15, wherein the computer readable program code instructions, when executed by the computer processing unit, further cause the computer processing unit to:
display a plurality of different selectable optimization analysis domains that are each associated with different ones of the displayed root subsets and the displayed branch subsets; and
in response to a selection of one of the displayed optimization analysis domains, generate a list of different optimization solutions of a one of the displayed root subsets and the displayed branch subsets that is associated with the selected displayed optimization analysis domain, wherein each of the different optimization solutions display different respective values of generated savings of at least one of the operating costs over time data of the collected data and the energy costs over time data of the collected data.

17. The computer program product of claim 16, wherein the plurality of different selectable analytics modules comprises hardware optimization, storage optimization, network optimization, software optimization, energy optimization, labor optimization, and data center facilities optimization modules.

18. The computer program product of claim 17, wherein the components are servers, and the collected software identity indicia data comprises database software identities operating on each of the servers.

19. The computer program product of claim 18, wherein the list of different optimization solutions comprises a consolidation of the servers optimization solution that generates a first amount of savings of the operating costs over time data, a virtualization of the servers optimization solution that generates a second amount of savings of the operating costs over time data that is different from the first amount of savings, and a migration of the servers optimization solution that generates a third amount of savings of the operating costs over time data that is different from at least one the first amount of savings and the second amount of savings.

20. The computer program product of claim 19, wherein the computer readable program code instructions, when executed by the computer processing unit, further cause the computer processing unit to, in response to a selection of one of the listed optimization options, display details of assumptions made from one or more of the collected geographic location, hardware identity indicia, software identity indicia, operating costs over time and energy costs over time data in generating the selected optimization option.
